(19) United States
(12) Patent Application Publication
(10) Pub. No.: US 2009/0115572 A1
(43) Pub. Date: May 7, 2009

(54) SYSTEM AND ASSOCIATED METHOD FOR TRACKING LUGGAGE DURING TRAVEL

(76) Inventors: Anil I. Valbh, Orlando, FL (US); Kiran C. Chhaganlal, Winter Springs, FL (US)

Correspondence Address: Michael L. Leetzow, Esq.;Michael L. Leetzow, P.A., 5213 SHORELINE CIRCLE, SANFORD, FL, 32771, US

(21) Appl. No.: 11/934,438

(22) Filed: Nov. 2, 2007

(51) Int. Cl. H04Q 1/30; G08B 5/22; H04Q 7/00

(52) U.S. Cl. 340/7.58

(57) ABSTRACT

A system for tracking luggage is provided so that a traveler may know where the luggage arrives. The system can notify the traveler of the arrival of the luggage at a destination and allows for the traveler and luggage to be reunited in quicker, more efficient manner. A method of using the system is also provided.

### BACKGROUND OF THE INVENTION

1. Field of the Invention

The present invention relates generally to a system and a method for tracking luggage during travel, and particularly to a system and a method for tracking luggage and keeping a record of the location that is accessible to the traveler to locate the luggage at any time.

2. Technical Background

There are many ways to identify luggage once it has arrived at its destination. Many people mark their luggage in creative and unique ways so as to be able to identify it once the luggage makes it to the baggage claim area. There are even systems that respond to a remote control to send up a flag for the traveler to locate the bag. Other systems allow passengers to know if the luggage is on the plane. However, if the luggage does not make it on the plane, then the person has no way of knowing where the luggage is, only where it is not. Other systems follow luggage through a facility and have markings that identify the luggage and the traveler. However, there is no method for notifying or allowing a traveler to know the location of the luggage in the event that the luggage becomes lost. Additionally, once the luggage becomes lost and arrives at a different location, the luggage handlers typically have no way to notify the traveler of the new location of the luggage.

It would be desirable therefore to provide a system and method that is easily installed, reliable, cost-effective, and allows for easier location of the traveler's luggage at any time during travel.

### SUMMARY OF THE INVENTION

Disclosed herein is a method for tracking luggage of a traveler during travel that includes the steps of registering an identification tag, the identification tag having data associated therewith; initializing a travel record corresponding to the identification tag for the luggage to be tracked, the tracked luggage starting travel from a first location; updating the travel record from a second location after the tracked luggage arrives at the second location; and notifying an authorized person of the arrival of the tracked luggage at the second location after the travel record is updated.

In another aspect, method for tracking luggage during travel that includes the steps of attaching an identification tag to the luggage, the identification tag having data associated therewith, the data associated with the identification tag being stored in a central location, scanning the identification tag at a first location, the first location being a departure location, updating the data associated with the identification tag with data regarding travel of the traveler, scanning the identification tag at a second location, the second location being a different location than the first location, updating the data associated with the identification tag after the tracked luggage is scanned at the second location, and notifying an authorized person of the arrival of the tracked luggage at the second location after the data is updated.

In yet another aspect, the present invention is directed to a system for tracking luggage of a traveler during travel that includes a plurality of identification tags, each of the plurality of identification tags having data associated therewith, a central storage device, the central storage device being capable of storing data associated with each of the plurality of identification tags, an input device capable of communicating with the central storage device for inputting data into the central storage device, the data being associated with one of the plurality of identification tags, and a communication device, the communication device capable of retrieving data associated with at least one of the plurality of identification tags and displaying the retrieved data to an authorized person.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is schematic of one embodiment of a system according to the present invention;

FIG. 2 is a flow chart illustrating one embodiment of a method according to the present invention; and

FIG. 3 is a flow chart illustrating another embodiment of a method according to the present invention.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

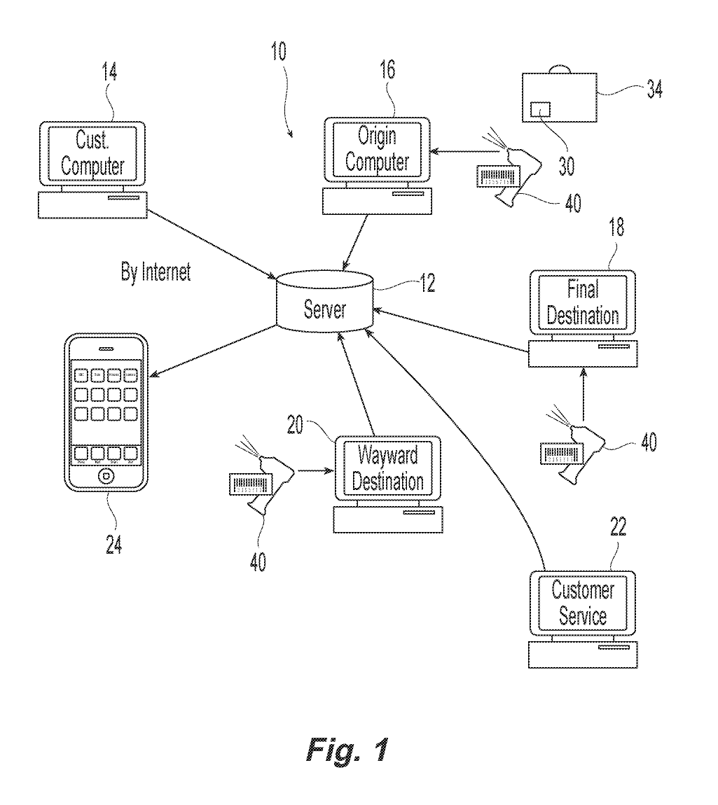

Referring to FIG. 1, one embodiment of a system 10 according to the present invention is illustrated. A server 12 is remotely located from a number of terminals, the server 12 can be remotely accessed. For example, the server 12 can be remotely accessed by a customer through a terminal 14, which is illustrated as the customer's computer that has access to the internet that in turn has to access to the server 12. Similarly, a number of other terminals would also be able to access the server, including for example, a terminal 16 at an airport at the beginning of the trip, a terminal 18 at an airport at the customer's destination, a terminal 20 at another location which is not an intended destination (wayward destination), and a terminal 22 at a customer service location. It should be noted that the server 12 can be accessed by more terminals than those shown in FIG. 1. The server 12 also has the ability to communicate with other communication devices 24, such as a hand held personal digital assistant.

Also associated with the system is an identification tag 30, which is preferably an RFID tag, the identification tag 30 having a unique identification code associated therewith. The identification tag 30 may also be a scannable tag with a bar code or another easily identifiable code. The identification tag is attached to a suitcase 34 or other object that is to be checked with an airline or other commercial carrier for transportation to the same location as the traveler. The location of the identification tag 30 on the suitcase 34 is not critical except that the identification tag 30 must be easily readable or scannable in the environment in which it is to be scanned, e.g., a conveyor belt, baggage handling system, etc.

Each of the terminals will have associated therewith a scanner 40 that will be able to read or receive the unique identification code associated with each of the identification tags 30. The type of scanner 40 will depend on the type of identification tags that are used with the system. For example, for identification tags 30 that have bar codes, the scanners should be able to scan bar codes and for those identification tags 30 that have RFID tags, the scanners 40 should be able to read the RFID tags.

The scanners 40 may be directly connected to the respective terminals to transmit data through the terminals to the server 12, or the scanners 40 may store the data from the identification tags 30 for subsequent downloading to the server 12 after the scanners are connected to the terminals. The scanners may be connected to the terminals in any manner and be within the scope of the present invention.

As illustrated in FIG. 1, the system 10 may also include a hand held device 24, such as a PDA, smart phone, cell phone, etc. so that the location of the luggage or suitcase may be sent to the hand held device 24. As described in more detail below, the traveler may provide a number of addresses, phone numbers, or other contact information so that the system 10 may notify the traveler of any updated information regarding the location of the suitcases 34.

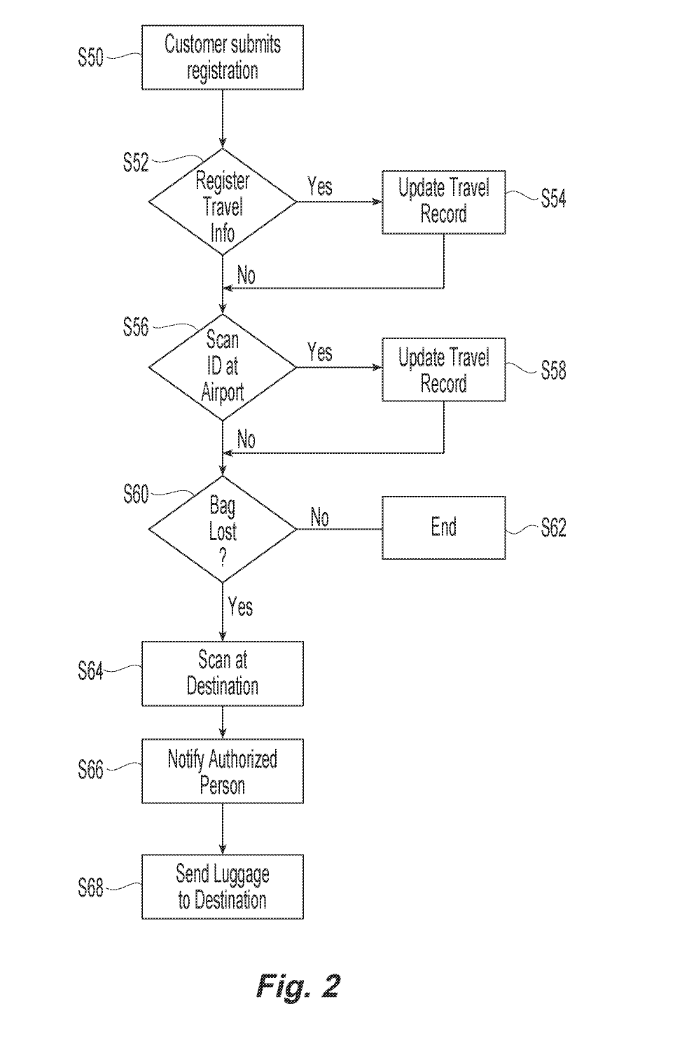

One method of operation of the present invention will now be described in conjunction with FIG. 2. At step S50 the customer registers an identification tag 30. The traveler would submit pertinent information regarding the traveler and preferences, creating a travel record for that traveler. Such information would preferably include name, addresses, email address, telephone phone numbers, emergency telephone numbers, login name and password. This registration can be accomplished in a number of ways, including for example, by mail, over the internet, by telephone, etc. The traveler preferably includes a contact address (email address or phone number or multiple phone numbers) to be used during travel. Optionally, the traveler may also identify more than one contact address, one of which may be another authorized person. At step S52, the traveler may decided to input additional information regarding a particular trip. If the traveler wishes to add the information, that information is added to the travel record at step S54. For example, the traveler may put in multiple destinations, specific hotel or lodging information, flights on other airlines if the traveler will be changing flights/airlines, or flying internationally. The traveler may also put in a final destination with an approximate arrival time so that the airline with the wayward luggage would know when the traveler is arriving, as explained in more detail below. The process then moves on to step S56, where the luggage may be scanned at the departing airport. If the luggage is scanned, the travel record is updated at step S58. If not, the process moves along to step S60 where it is determined if a particular piece of luggage is lost. If the luggage is not lost, then the traveler will be able to retrieve the luggage at the baggage claim area and the process ends at step S62.

The determination of whether the baggage is lost at step S60 may occur in a number of ways, which includes the process the airlines currently use to determine lost baggage. That is, the luggage may not be picked up by a traveler at the baggage claim area. Alternatively, the airlines may determine from scanning the current bar codes on the luggage when it arrives at a particular destination that the luggage is at the wrong airport. Once the luggage is determined to be lost, the airline or airport personnel scan the lost baggage with a scanner 40 at step S64. The travel record is then updated with the current location of the luggage and the traveler is notified at step S66 of the location of the luggage. The airline personnel will also have the contact information and, if the information was entered at step S52, the final destination for the traveler. The airline can then arrange, with the cooperation of the traveler, to have the wayward luggage delivered to the traveler in the most expedient manner at step S68.

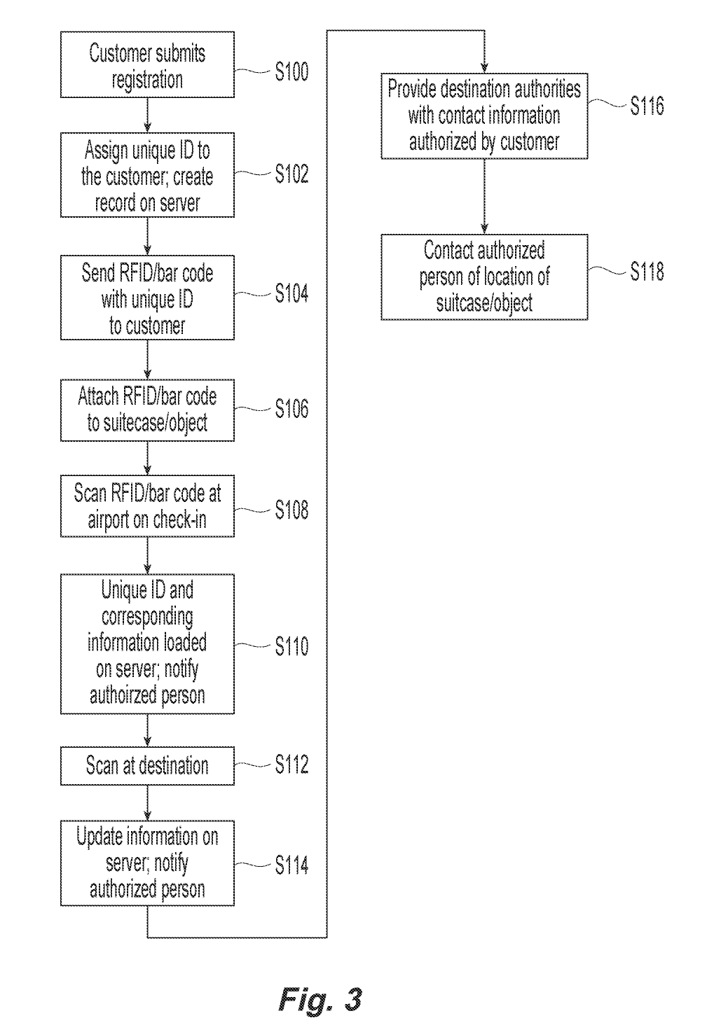

The operation of the present invention according to a second embodiment will now be described in conjunction with FIG. 3. At step S100, the traveler can submit a registration for an identification tag 30. The traveler would submit pertinent information regarding the traveler and preferences. Such information would preferably include name, addresses, email address, telephone phone numbers, emergency telephone numbers, login name and password. This registration can be accomplished in a number of ways, including for example, by mail, over the internet, by telephone, etc. The traveler preferably includes a contact address (email address or phone number) to be used during travel. Optionally, the traveler may also identify more than one contact address, one of which may be another authorized person. Once the traveler has registered, a unique identification number that is associated with the identification tag 30 is assigned to the traveler at step S102. The traveler may request more than one identification tag 30, depending on the number of suitcases/objects 34 that are to be tracked during travel. The information regarding the traveler is entered into a database on the server, and is later accessible by the traveler by logging on and entering the correct login name and password. The identification tags are sent to the traveler at step S104 with instructions on how and where to attach the identification tags to the suitcases 34. The database may allow the traveler to enter more specific information for each identification tag 30. For example, the traveler may enter information about the manufacturer, color, dimensions, or other physical characteristics about the suitcase 34 to make subsequent identification and location easier. The traveler then attaches the identification tag 30 to the suitcase 34 at step S106 in accordance with the instructions provided with the identification tag 30.

When the traveler departs from an airport (or other appropriate starting point), each identification tag 30 is scanned to provide a starting location in the database at step S108. Optionally, the traveler can enter specific travel information about a trip in advance. For example, the traveler can enter information about departure and arrival dates and times, flight numbers, and contact numbers at the travel destinations. The scanned data is then associated with the traveler's information, starting a travel record for the traveler and the particular trip at step S110. The system 10 may then notify the traveler through a method previously identified by the traveler.

At step S112, the identification tag 30 on suitcase 34 is scanned at a destination. At step S114, the travel record is updated and the traveler or other authorized person is then notified of the arrival of the suitcase 34 at the destination. The traveler will know if the suitcase 34 has arrived at the appropriate location, and, if at the appropriate location, the traveler can retrieve the suitcase 34 in the baggage claim area.

If the destination does not agree with the travel record for the identification tag 30, the appropriate people at the wrong location and the intended destination may also be notified so that the suitcase 34 can be identified or flagged and the correct destination be provided at step S116. The traveler may also be notified that the suitcase has arrived at an incorrect destination in a separate method from that described above (i.e., that the luggage has arrived at a destination when the travel record is updated). The suitcase 34 can then be routed to the correct destination since the correct destination would be in the travel record associated with the identification tag 30 on the suitcase 34. The travel record may be updated with the appropriate information about sending the suitcase so that the traveler will know when to expect the suitcase 34 to arrive at the correct location. The people at the wrong destination will also be provided with a contact number or address for the traveler so that the traveler can be notified by them as to the location of the suitcase 34 and the plans for sending the suitcase 34 to the appropriate destination at step S118 rather than just relying on the system to alert the traveler. The suitcase 34 will then be scanned with it leaves the wrong location and is on the way to the correct (or even a new) destination and the travel record is updated. Upon arrival at the correct destination, the system will notify the travel or authorized person of the arrival of the suitcase 34, so that the traveler may arrange to retrieve it.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A method for tracking luggage of a traveler during travel comprising the steps of:
registering an identification tag, the identification tag having data associated therewith;
initializing a travel record corresponding to the identification tag for the luggage to be tracked, the tracked luggage starting travel from a first location;
updating the travel record from a second location after the tracked luggage arrives at the second location; and
notifying an authorized person of the arrival of the tracked luggage at the second location after the travel record is updated.

2. The method for tracking luggage according to claim 1, wherein the step of registering the identification tag comprises associating traveler information with the identification tag.

3. The method for tracking luggage according to claim 1, wherein the identification tag comprises an RFID tag.

4. The method for tracking luggage according to claim 1, wherein the tag is a scannable tag.

5. The method for tracking luggage according to claim 1, wherein the tag includes a bar code.

6. The method for tracking luggage according to claim 1, wherein the data associated with the identification tag includes at least one of a unique code associated with the identification tag, a telephone number, an email address, a destination address, and an electronic address.

7. The method for tracking luggage according to claim 1, wherein the registration occurs over a computer network.

8. The method for tracking luggage according to claim 1, wherein the registration occurs over a telephone line.

9. The method for tracking luggage according to claim 1, wherein updating the travel record includes associating an arrival location with the identification tag.

10. The method for tracking luggage according to claim 1, wherein the initializing of a travel record includes associating data with the identification tag, the data including at least one of a starting location, a destination location, a flight number, contact information, a luggage carrier identity, and an arrival date.

11. The method of tracking luggage according to claim 1, wherein the data associated with the identification tag is stored on a computer server.

12. The method of tracking luggage according to claim 1, wherein the step of notifying the authorized person is by a method selected from the group of email, telephone call, and instant message.

13. The method of tracking luggage according to claim 1, wherein the authorized person is at least one of the traveler and a luggage carrier representative.

14. The method of tracking luggage according to claim 1, wherein the step of notifying the authorized person is allowing the authorized person access to the updated record.

15. The method of tracking luggage according to claim 1, wherein the data includes tag data to identify the identification tag and data associated with the traveler.

16. The method of tracking luggage according to claim 1, further comprising the step of updating the travel record upon notifying the authorized person.

17. The method of tracking luggage according to claim 1, further comprising the step of updating the travel record after the traveler acquires the luggage.

18. A method for tracking luggage during travel comprising the steps of:
attaching an identification tag to the luggage, the identification tag having data associated therewith, the data associated with the identification tag being stored in a central location;
scanning the identification tag at a first location, the first location being a departure location;
updating the data associated with the identification tag with data regarding travel of the traveler;
scanning the identification tag at a second location, the second location being a different location than the first location;
updating the data associated with the identification tag after the tracked luggage is scanned at the second location; and
notifying an authorized person of the arrival of the tracked luggage at the second location after the data is updated.

19. The method of tracking luggage according to claim 18, further comprising the steps of:
sending a message from the authorized person through the central location to a worker at the second location to send the luggage to a third location, the third location being the location of the traveler.

20. The method of tracking luggage according to claim 18, further comprising the step of updating the travel record upon notifying the authorized person.

21. The method of tracking luggage according to claim 18, further comprising the step of updating the travel record after the traveler acquires the luggage.

22. A system for tracking luggage of a traveler during travel comprising:
a plurality of identification tags, each of the plurality of identification tags having data associated therewith;
a central storage device, the central storage device being capable of storing data associated with each of the plurality of identification tags;
a input device capable of communicating with the central storage device for inputting data into the central storage device, the data being associated with one of the plurality of identification tags; and
a communication device, the communication device capable of retrieving data associated with at least one of the plurality of identification tags and displaying the retrieved data to an authorized person.

23. The system according to claim 22, wherein the identification tag comprises an RFID tag.

24. The system according to claim 22, wherein the identification tag is a scannable tag.

25. The system according to claim 22, wherein the input device is capable of associating data with one of the plurality of identification tags.

26. The system according to claim 22, wherein the input device is a portable scanner.

27. The system according to claim 22, wherein the communication device is selected from the group of devices including a personal digital assistant, a cell phone, a smart phone, and a computer.

28. The system according to claim 22, wherein the central storage device includes a communicator, the communicator being capable electronically transmitting information related to the plurality of identification tags, the transmitted information begin associated with a particular one of the plurality of identification tags, and the transmitted information being sent only to the authorized person.
